(19) United States
(12) Patent Application Publication
(10) Pub. No.: US 2019/0315005 A1
(43) Pub. Date: Oct. 17, 2019

(54) Multi-Function Hand Tool

(71) Applicant: Strike Industries, Inc., Santa Ana, CA (US)

(72) Inventor: YiHuei Jen, Santa Ana, CA (US)

(21) Appl. No.: 15/953,442

(22) Filed: Apr. 14, 2018

(51) Int. Cl. B26B 11/00; B26B 9/02; B25B 15/00; B25F 1/04; H02G 1/12; B67B 7/16

(52) U.S. Cl. CPC B26B 11/006; B26B 9/02; B25B 15/007; B25B 15/005; H02G 1/1209; B67B 7/16; B25F 1/04

(57) ABSTRACT

A multi-function hand tool includes a handle and a blade. The handle includes a first distal end and a second distal end opposite the first distal end. The blade includes a tip as a first distal end and a tang as a second distal end opposite the first distal end. The blade also includes a spine and a functional edge opposite the spine. The second distal end of the blade is attached to the first distal end of the handle to allow the blade to extend from the first distal end of the handle with the tip of the blade forming a first distal end of the hand tool and the second distal end of the handle forming a second distal end of the hand tool. The tip of the blade includes a flat tip configured to drive at least a slotted screw head of a screw.

### TECHNICAL FIELD

The present disclosure is generally related to hand tools and, more particularly, to a multi-function hand tool.

### BACKGROUND

Unless otherwise indicated herein, approaches described in this section are not prior art to the claims listed below and are not admitted as prior art by inclusion in this section.

Multi-tools, or multitools, refer to portable, versatile hand tools having multiple functions built in a single unit. Some multi-tools are small and compact in size, and thus can be carried in a wallet or on a keyring. Some multi-tools are designed to be carried in a pocket or a belt-mounted pouch.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a multi-function hand tool may include a handle and a blade. The handle may include a first distal end and a second distal end opposite the first distal end. The blade may include a tip as a first distal end and a tang as a second distal end opposite the first distal end. The blade may also include a spine and a functional edge opposite the spine. The second distal end of the blade may be attached to the first distal end of the handle to allow the blade to extend from the first distal end of the handle with the tip of the blade forming a first distal end of the hand tool and the second distal end of the handle forming a second distal end of the hand tool. The functional edge of the blade may include at least a first cutting edge and a second cutting edge. The functional edge of the blade may also include at least one concave edge that is located between the first cutting edge and the second cutting edge.

In one aspect, a multi-function hand tool may include a handle and a blade. The handle may include a first distal end and a second distal end opposite the first distal end. The blade may include a tip as a first distal end and a tang as a second distal end opposite the first distal end. The blade may also include a spine and a functional edge opposite the spine. The second distal end of the blade may be attached to the first distal end of the handle to allow the blade to extend from the first distal end of the handle with the tip of the blade forming a first distal end of the hand tool and the second distal end of the handle forming a second distal end of the hand tool. The tip of the blade may include a flat tip configured to drive at least a slotted screw head of a screw.

In one aspect, a multi-function hand tool may include a handle and a blade. The handle may include a first distal end and a second distal end opposite the first distal end. The blade may include a tip as a first distal end and a tang as a second distal end opposite the first distal end. The blade may also include a spine and a functional edge opposite the spine. The second distal end of the blade may be attached to the first distal end of the handle to allow the blade to extend from the first distal end of the handle with the tip of the blade forming a first distal end of the hand tool and the second distal end of the handle forming a second distal end of the hand tool. The tip of the blade may include a cutting edge generally perpendicular to a longitudinal axis of the hand tool.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 is a diagram of a side view of a multi-function hand tool in accordance with an implementation of the present disclosure.

FIG. 2 is a diagram of a side view of a multi-function hand tool in accordance with an implementation of the present disclosure.

FIG. 3 is a diagram of a top view of a multi-function hand tool in accordance with an implementation of the present disclosure.

FIG. 4 is a diagram of a rear view of a multi-function hand tool in accordance with an implementation of the present disclosure.

FIG. 5 is a diagram of a perspective view of a multi-function hand tool in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

The position terms used in the present disclosure, such as “front”, “forward”, “rear”, “back”, “top”, “bottom”, “left”, “right”, “head”, “tail” or the like assume a firearm in the normal firing position, with the firearm being in a position in which the longitudinal axis of the barrel of the firearm runs generally horizontally and the direction of firing points “forward” away from the operator or user of the firearm. The same convention applies for the direction statements used herein.

As used herein, the terms “proximal” and “proximally” may denote “forward” and “forwardly” with respect to the firearm, and the terms “distal” and “distally” may denote “rearward” and “rearwardly” with respect to the firearm. As used herein, the verb “to comprise” in this description, claims, and other conjugations are used in its non-limiting sense to mean those items following the word are included, but items not specifically mentioned are not excluded. As used herein, the word “forward” means moving in the direction that the projectile moves during firing a firearm. As used herein, the word “proximal” means closer to the reference point, in this case, the shooter. As used herein, the word “distal” means farther to the reference point, in this case, the shooter. Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g. 1 to 5 includes 1, 1.5, 2, 2.75, 3, 3.80, 4, and 5). All dimensions given herein are by way of examples to better illustrate the present disclosure embodiments and shall not be construed to limit the dimensions of the present disclosure embodiments to the given numeric values.

### Overview

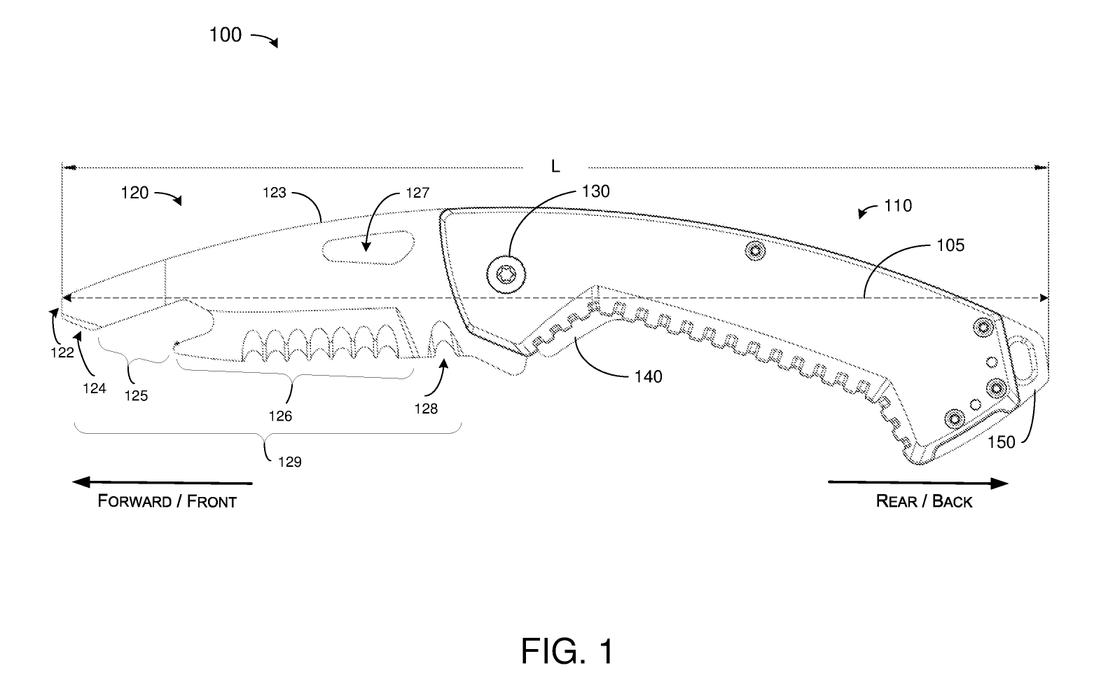

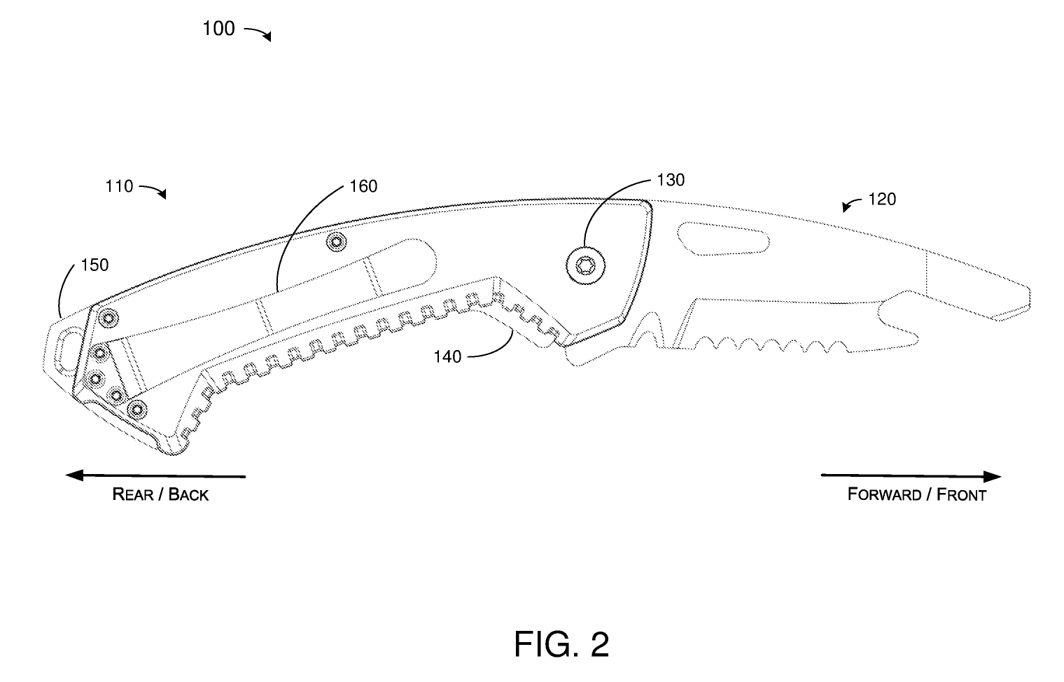

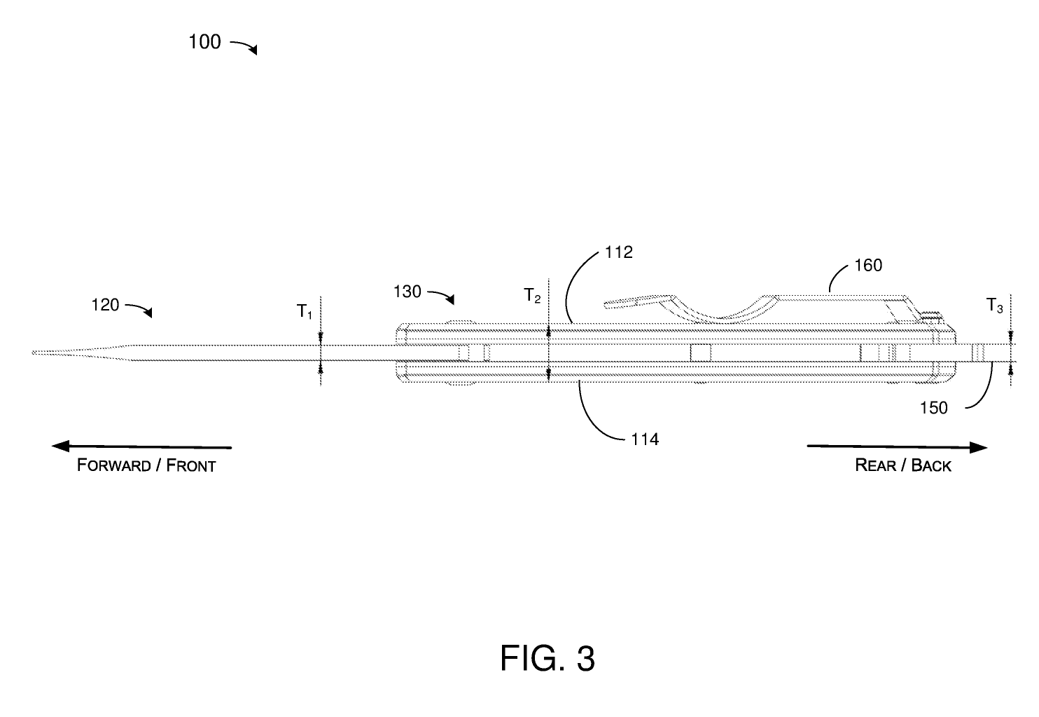

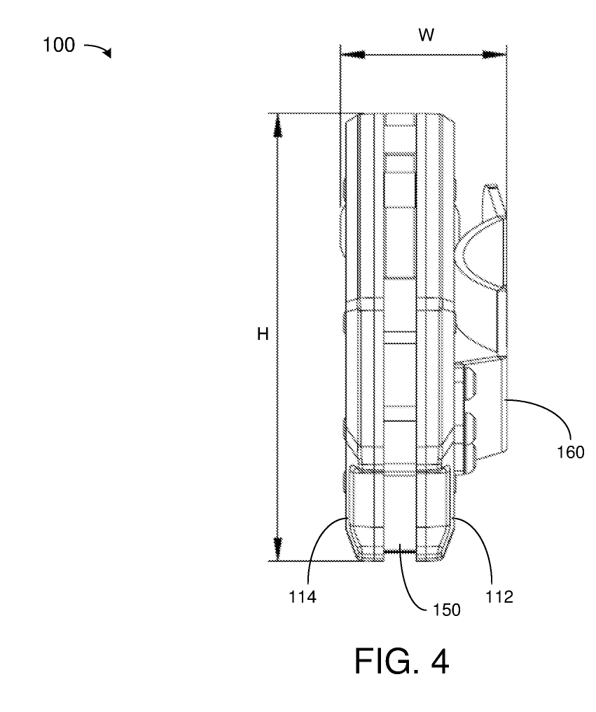

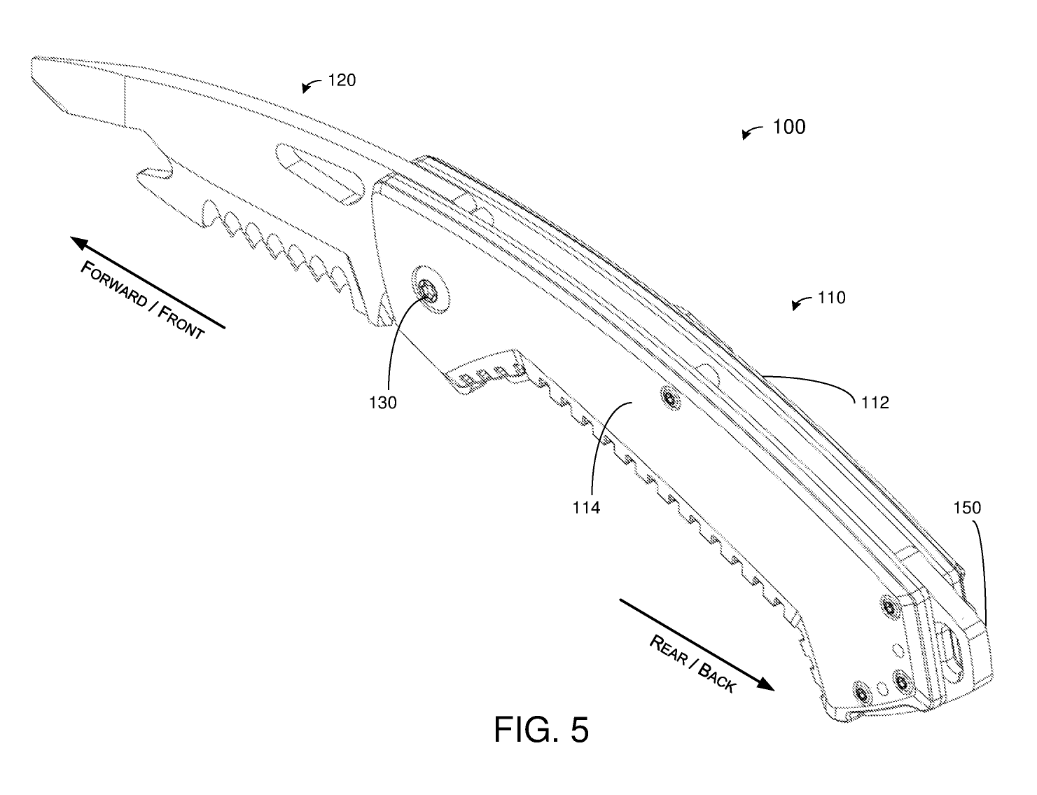

FIG. 1˜FIG. 5 illustrate various views of a multi-function hand tool 100 in accordance with an implementation of the present disclosure. Specifically, FIG. 1 illustrates a left view of multi-function hand tool 100, FIG. 2 illustrates a right view of multi-function hand tool 100, FIG. 3 illustrates a top view of multi-function hand tool 100, FIG. 4 illustrates a rear view of multi-function hand tool 100, and FIG. 5 illustrates a perspective view of multi-function hand tool 100.

Referring to FIG. 1˜FIG. 5, multi-function hand tool 100 may include a handle 110 and a blade 120. Handle 110 may include a first distal end (e.g., the end pointing toward the front in FIG. 1) and a second distal end (e.g., the end pointing toward the back in FIG. 1) opposite the first distal end. Blade 120 may include a tip 122 as a first distal end of blade 120 and a tang (not shown, as it is obstructed by handle 110) as a second distal end of blade 120 opposite the first distal end of blade 120. Blade 120 may also include a spine 123 and a functional edge 129 opposite spine 123. The tang, as the second distal end of blade 120, may be attached to the first distal end of handle 110 to allow blade 120 to extend from the first distal end of handle 110 with tip 122 of blade 120 forming a first distal end of multi-function hand tool 100 and the second distal end of handle 110 (e.g., the hilt or butt thereof) forming a second distal end of multi-function hand tool 100. Referring to FIG. 1, functional edge 129 of blade 120 may include at least a first cutting edge 124 and a second cutting edge 126. Moreover, functional edge 129 of blade 120 may include at least one concave edge 125 that is located between first cutting edge 124 and second cutting edge 126. Blade 120 may also include an opening 127 to reduce weight. The term “cutting edge” herein refers to an edge of blade 120 that is sharp and thus able to cut or slice through a piece of material. The term “non-cutting edge” herein refers to an edge of blade 120 that is thick, or dull, and not sharp.

In some implementations, tip 122 of blade 120 may include a flat tip configured to drive at least a slotted screw head of a screw. In some implementations, tip 122 of blade 120 may also be configured to drive at least a cross-head screw head (e.g., Phillips, Frearson and the like) of a screw. In such cases, tip 122 may be utilized at least for driving screws. Alternatively, or additionally, tip 122 of blade 120 may include a cutting edge (e.g., a plain edge) generally perpendicular to a longitudinal axis 105 of multi-function hand tool 100 when blade 120 is in an open position (e.g. as that shown in FIG. 1, FIG. 2, FIG. 3 and FIG. 5). In such cases, tip 122 may be utilized at least for cutting.

In some implementations, first cutting edge 124 may be located between tip 122 of blade 120 and concave edge 125.

In some implementations, as shown in FIG. 1, FIG. 2 and FIG. 5, concave edge 125 may be contoured as a bottle opener and configured to remove metal bottle caps (e.g., 21-tooth crown cork bottle cap) from bottles. In some implementations, concave edge 125 may be a non-cutting edge. Alternatively, concave edge 125 may be a cutting edge.

In some implementations, first cutting edge 124 may include a plain edge. Thus, first cutting edge 124 may be utilized at least for cutting. In some implementations, second cutting edge 126 may include a serrated edge with a plurality of serrations. Thus, second cutting edge 126 may be utilized at least for slicing or sawing in addition to cutting.

In some implementations, functional edge 129 of blade 120 may also include a notch 128 configured to strip an electrical insulation from an electric wire. Thus, notch 128 may be utilized at least for wire stripping.

In some implementations, multi-function hand tool 100 may further include a pivot mechanism 130. Pivot mechanism 130 may include a pivot screw and a pivot. Blade 120 may be pivotably attached to the first distal end of handle 110 by pivot mechanism 130. Handle 110 may include a first half piece 112 and a second half piece 114 with pivot mechanism 130 sandwiched between first half piece 112 and second half piece 114 of handle 110. When in an open position, tip 122 of blade 120 may generally point away from a user and the second distal end of handle 110 may generally point towards the user with spine 123 of blade 120 facing towards a top side of multi-function hand tool 100 (e.g., upward in FIG. 1). When in a closed position, tip 122 of blade 120 may be sandwiched between first half piece 112 and second half piece 114 of handle 110 with spine 123 of blade 120 facing towards a bottom side (e.g., downward in FIG. 1) of multi-function hand tool 100 opposite the top side thereof.

In some implementations, multi-function hand tool 100 may further include an elastic component 140 sandwiched between first half piece 112 and second half piece 114 of handle 110. When in a first position, elastic component 140 may prevent blade 120 from moving away from the open position. When in a second position, elastic component 140 may allow blade 120 to move between the open position and the closed position. For instance, elastic component 140 may be a cantilever spring that is fixed at one end (e.g., toward the second distal end of handle 110) and free to move sideways (e.g., between first half piece 112 and second half piece 114) at the opposite end (e.g., toward the first distal end of handle 110).

In the example shown in FIG. 1, as a cantilever spring, the fixed end of elastic component 140 may be affixed, attached or otherwise mounted to first half piece 112 of handle 110. When in the first position, the free (non-fixed) end of elastic component 140 leans toward the reader (e.g., out of the page) and come in contact with the tang (the second distal end) of blade 120, thereby preventing blade 120 from pivoting around pivot mechanism 130. When pushed to the second position by a user, the free (non-fixed) end of elastic component 140 is pressed toward or against first half piece 112 of handle 110 to be away from the tang (the second distal end) of blade 120, thereby allowing blade 120 to move between the open position and the closed position in which blade 120 is retracted or otherwise received in handle 110 between first half piece 112 and second half piece 114.

In some implementations, multi-function hand tool 100 may also include an end piece 150 sandwiched between first half piece 112 and second half piece 114 of handle 110 and near the second distal end of handle 110 (e.g., facing the back in FIG. 1). End piece 150 may include a through hole that allows a lanyard, a ring or a string to pass through.

In some implementations, multi-function hand tool 100 may further include a clip 160 attached to either first half piece 112 or second half piece 114 of handle 110. Referring to FIG. 2, FIG. 3 and FIG. 4, clip 160 may be configured to allow multi-function hand tool 100 to be somewhat securely stored on a belt, a belt-mounted pouch, a trouser pocket or a shirt pocket of the user.

In some implementations, blade 120 may be made of a metallic material such as, for example and without limitation, stainless steel. Alternatively, blade 120 may be made of ceramics. In some implementations, handle 110 may be made of polymers, plastics, rubber, silicone, wood or ceramics. Alternatively, handle 110 may be made of a metallic material.

Referring to FIG. 1˜FIG. 5, an overall length of multi-function hand tool 100, measured along longitudinal axis 105, may be L when blade 120 is in its open position. A thickest portion of blade 120 may have a thickness of T₁. A spacing between first half piece 112 and second half piece 114 of handle 110 may have a dimension of T₂, which is greater than T₁ to accommodate blade 120. A thickness of end piece may be T₃. An overall height of multi-function hand tool 100, measured from its top side and bottom side, may be H. A width of multi-function hand tool 100, measured from second half piece 114 to clip 160, may be W.

### Highlight of Select Features

In one aspect, a multi-function hand tool may include a handle and a blade. The handle may include a first distal end and a second distal end opposite the first distal end. The blade may include a tip as a first distal end and a tang as a second distal end opposite the first distal end. The blade may also include a spine and a functional edge opposite the spine. The second distal end of the blade may be attached to the first distal end of the handle to allow the blade to extend from the first distal end of the handle with the tip of the blade forming a first distal end of the hand tool and the second distal end of the handle forming a second distal end of the hand tool. The functional edge of the blade may include at least a first cutting edge and a second cutting edge. The functional edge of the blade may also include at least one concave edge that is located between the first cutting edge and the second cutting edge.

In some implementations, the tip of the blade may include a flat tip configured to drive at least a slotted screw head of a screw. Alternatively, or additionally, the tip of the blade may include a cutting edge generally perpendicular to a longitudinal axis of the hand tool.

In some implementations, the first cutting edge may be located between the tip of the blade and the at least one concave edge.

In some implementations, the at least one concave edge may be contoured as a bottle opener and configured to remove metal bottle caps from bottles.

In some implementations, the first cutting edge may include a plain edge, and the second cutting edge may include a serrated edge.

In some implementations, the functional edge of the blade may also include a notch configured to strip an electrical insulation from an electric wire.

In some implementations, the hand tool may further include a pivot mechanism. The blade may be pivotably attached to the first distal end of the handle by the pivot mechanism. The handle may include a first half piece and a second half piece with the pivot mechanism sandwiched between the first half piece and the second half piece of the handle. When in an open position, the tip of the blade may generally point away from a user and the second distal end of the handle may generally point towards the user with the spine of the blade facing towards a top side of the hand tool. When in a closed position, the tip of the blade may be sandwiched between the first half piece and the second half piece of the handle with the spine of the blade facing towards a bottom side of the hand tool opposite the top side thereof.

In some implementations, the hand tool may further include an elastic component sandwiched between the first half piece and the second half piece of the handle. When in a first position, the elastic component may prevent the blade from moving away from the open position. When in a second position, the elastic component may allow the blade to move between the open position and the closed position.

In some implementations, the hand tool may further include a clip attached to either the first half piece or the second half piece of the handle.

In one aspect, a multi-function hand tool may include a handle and a blade. The handle may include a first distal end and a second distal end opposite the first distal end. The blade may include a tip as a first distal end and a tang as a second distal end opposite the first distal end. The blade may also include a spine and a functional edge opposite the spine. The second distal end of the blade may be attached to the first distal end of the handle to allow the blade to extend from the first distal end of the handle with the tip of the blade forming a first distal end of the hand tool and the second distal end of the handle forming a second distal end of the hand tool. The tip of the blade may include a flat tip configured to drive at least a slotted screw head of a screw.

In some implementations, the functional edge of the blade may include at least a first cutting edge and a second cutting edge, as well as at least one concave edge that is located between the first cutting edge and the second cutting edge. In some implementations, the first cutting edge may be located between the tip of the blade and the at least one concave edge.

In some implementations, the first cutting edge may include a plain edge, and the second cutting edge may include a serrated edge. Moreover, the functional edge of the blade may also include a notch configured to strip an electrical insulation from an electric wire.

In some implementations, the hand tool may further include a pivot mechanism. The blade may be pivotably attached to the first distal end of the handle by the pivot mechanism. The handle may include a first half piece and a second half piece with the pivot mechanism sandwiched between the first half piece and the second half piece of the handle. When in an open position, the tip of the blade may generally point away from a user and the second distal end of the handle generally points towards the user with the spine of the blade facing towards a top side of the hand tool. When in a closed position, the tip of the blade may be sandwiched between the first half piece and the second half piece of the handle with the spine of the blade facing towards a bottom side of the hand tool opposite the top side thereof.

In some implementations, the hand tool may further include an elastic component sandwiched between the first half piece and the second half piece of the handle. When in a first position, the elastic component may prevent the blade from moving away from the open position. When in a second position, the elastic component may allow the blade to move between the open position and the closed position.

In one aspect, a multi-function hand tool may include a handle and a blade. The handle may include a first distal end and a second distal end opposite the first distal end. The blade may include a tip as a first distal end and a tang as a second distal end opposite the first distal end. The blade may also include a spine and a functional edge opposite the spine. The second distal end of the blade may be attached to the first distal end of the handle to allow the blade to extend from the first distal end of the handle with the tip of the blade forming a first distal end of the hand tool and the second distal end of the handle forming a second distal end of the hand tool. The tip of the blade may include a cutting edge generally perpendicular to a longitudinal axis of the hand tool.

In some implementations, the functional edge of the blade may include at least a first cutting edge and a second cutting edge, as well as at least one concave edge that is located between the first cutting edge and the second cutting edge. In some implementations, the first cutting edge may be located between the tip of the blade and the at least one concave edge.

In some implementations, the first cutting edge may include a plain edge, and the second cutting edge may include a serrated edge. Moreover, the functional edge of the blade may also include a notch configured to strip an electrical insulation from an electric wire.

In some implementations, the hand tool may further include a pivot mechanism. The blade may be pivotably attached to the first distal end of the handle by the pivot mechanism. The handle may include a first half piece and a second half piece with the pivot mechanism sandwiched between the first half piece and the second half piece of the handle. When in an open position, the tip of the blade may generally point away from a user and the second distal end of the handle may generally point towards the user with the spine of the blade facing towards a top side of the hand tool. When in a closed position, the tip of the blade may be sandwiched between the first half piece and the second half piece of the handle with the spine of the blade facing towards a bottom side of the hand tool opposite the top side thereof.

In some implementations, the hand tool may further include an elastic component sandwiched between the first half piece and the second half piece of the handle. When in a first position, the elastic component may prevent the blade from moving away from the open position. When in a second position, the elastic component may allow the blade to move between the open position and the closed position.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A hand tool, comprising:
a handle having a first distal end and a second distal end opposite the first distal end; and
a blade comprising a tip as a first distal end and a tang as a second distal end opposite the first distal end, the blade further comprising a spine and a functional edge opposite the spine,
wherein the second distal end of the blade is attached to the first distal end of the handle to allow the blade to extend from the first distal end of the handle with the tip of the blade forming a first distal end of the hand tool and the second distal end of the handle forming a second distal end of the hand tool,
wherein the functional edge of the blade comprises at least a first cutting edge and a second cutting edge, and
wherein the functional edge of the blade further comprises at least one concave edge that is located between the first cutting edge and the second cutting edge.

2. The hand tool of claim 1, wherein the tip of the blade comprises a flat tip configured to drive at least a slotted screw head of a screw.

3. The hand tool of claim 1, wherein the tip of the blade comprises a cutting edge generally perpendicular to a longitudinal axis of the hand tool.

4. The hand tool of claim 1, wherein the first cutting edge is located between the tip of the blade and the at least one concave edge.

5. The hand tool of claim 1, wherein the at least one concave edge is contoured as a bottle opener and configured to remove metal bottle caps from bottles.

6. The hand tool of claim 1, wherein the first cutting edge comprises a plain edge, and wherein the second cutting edge comprises a serrated edge.

7. The hand tool of claim 1, wherein the functional edge of the blade further comprises a notch configured to strip an electrical insulation from an electric wire.

8. The hand tool of claim 1, further comprising:
a pivot mechanism,
wherein the blade is pivotably attached to the first distal end of the handle by the pivot mechanism,
wherein the handle comprises a first half piece and a second half piece with the pivot mechanism sandwiched between the first half piece and the second half piece of the handle,
wherein, when in an open position, the tip of the blade generally points away from a user and the second distal end of the handle generally points towards the user with the spine of the blade facing towards a top side of the hand tool, and
wherein, when in a closed position, the tip of the blade is sandwiched between the first half piece and the second half piece of the handle with the spine of the blade facing towards a bottom side of the hand tool opposite the top side thereof.

9. The hand tool of claim 8, further comprising:
an elastic component sandwiched between the first half piece and the second half piece of the handle,
wherein, when in a first position, the elastic component prevents the blade from moving away from the open position, and
wherein, when in a second position, the elastic component allows the blade to move between the open position and the closed position.

10. The hand tool of claim 9, further comprising:
a clip attached to either the first half piece or the second half piece of the handle.

11. A hand tool, comprising:
a handle having a first distal end and a second distal end opposite the first distal end; and
a blade comprising a tip as a first distal end and a tang as a second distal end opposite the first distal end, the blade further comprising a spine and a functional edge opposite the spine,
wherein the second distal end of the blade is attached to the first distal end of the handle to allow the blade to extend from the first distal end of the handle with the tip of the blade forming a first distal end of the hand tool and the second distal end of the handle forming a second distal end of the hand tool, and
wherein the tip of the blade comprises a flat tip configured to drive at least a slotted screw head of a screw.

12. The hand tool of claim 11, wherein the functional edge of the blade comprises at least a first cutting edge and a second cutting edge, wherein the functional edge of the blade further comprises at least one concave edge that is located between the first cutting edge and the second cutting edge, and wherein the first cutting edge is located between the tip of the blade and the at least one concave edge.

13. The hand tool of claim 12, wherein the first cutting edge comprises a plain edge, and wherein the second cutting edge comprises a serrated edge, and wherein the functional edge of the blade further comprises a notch configured to strip an electrical insulation from an electric wire.

14. The hand tool of claim 13, further comprising:
a pivot mechanism,
wherein the blade is pivotably attached to the first distal end of the handle by the pivot mechanism,
wherein the handle comprises a first half piece and a second half piece with the pivot mechanism sandwiched between the first half piece and the second half piece of the handle,
wherein, when in an open position, the tip of the blade generally points away from a user and the second distal end of the handle generally points towards the user with the spine of the blade facing towards a top side of the hand tool, and
wherein, when in a closed position, the tip of the blade is sandwiched between the first half piece and the second half piece of the handle with the spine of the blade facing towards a bottom side of the hand tool opposite the top side thereof.

15. The hand tool of claim 14, further comprising:
an elastic component sandwiched between the first half piece and the second half piece of the handle,
wherein, when in a first position, the elastic component prevents the blade from moving away from the open position, and
wherein, when in a second position, the elastic component allows the blade to move between the open position and the closed position.

16. A hand tool, comprising:
a handle having a first distal end and a second distal end opposite the first distal end; and
a blade comprising a tip as a first distal end and a tang as a second distal end opposite the first distal end, the blade further comprising a spine and a functional edge opposite the spine,
wherein the second distal end of the blade is attached to the first distal end of the handle to allow the blade to extend from the first distal end of the handle with the tip of the blade forming a first distal end of the hand tool and the second distal end of the handle forming a second distal end of the hand tool, and
wherein the tip of the blade comprises a cutting edge generally perpendicular to a longitudinal axis of the hand tool.

17. The hand tool of claim 16, wherein the functional edge of the blade comprises at least a first cutting edge and a second cutting edge, wherein the functional edge of the blade further comprises at least one concave edge that is located between the first cutting edge and the second cutting edge, and wherein the first cutting edge is located between the tip of the blade and the at least one concave edge.

18. The hand tool of claim 17, wherein the first cutting edge comprises a plain edge, and wherein the second cutting edge comprises a serrated edge, and wherein the functional edge of the blade further comprises a notch configured to strip an electrical insulation from an electric wire.

19. The hand tool of claim 18, further comprising:
a pivot mechanism,
wherein the blade is pivotably attached to the first distal end of the handle by the pivot mechanism,
wherein the handle comprises a first half piece and a second half piece with the pivot mechanism sandwiched between the first half piece and the second half piece of the handle,
wherein, when in an open position, the tip of the blade generally points away from a user and the second distal end of the handle generally points towards the user with the spine of the blade facing towards a top side of the hand tool, and
wherein, when in a closed position, the tip of the blade is sandwiched between the first half piece and the second half piece of the handle with the spine of the blade facing towards a bottom side of the hand tool opposite the top side thereof.

20. The hand tool of claim 19, further comprising:
an elastic component sandwiched between the first half piece and the second half piece of the handle,
wherein, when in a first position, the elastic component prevents the blade from moving away from the open position, and
wherein, when in a second position, the elastic component allows the blade to move between the open position and the closed position.
